(19) United States
(12) Patent Application Publication
(10) Pub. No.: US 2014/0173952 A1
(43) Pub. Date: Jun. 26, 2014

(54) OFFICE STATUS NOTIFIER

(71) Applicant: Janice Dill-Schmidt, Valencia, CA (US)

(72) Inventor: Janice Dill-Schmidt, Valencia, CA (US)

(21) Appl. No.: 14/192,708

(22) Filed: Feb. 27, 2014

Related U.S. Application Data
(63) Continuation-in-part of application No. 11/495,306, filed on Jul. 29, 2006, now abandoned.
Application No. 11/495,306 is a continuation of application No. 13/747,017, filed on Jan. 22, 2013, now abandoned.
Application No. 13/747,017 is a continuation of application No. 13/298,654, filed on Nov. 17, 2011, now abandoned.

(51) Int. Cl. G09F 11/06

(52) U.S. Cl. CPC G09F 11/06
USPC 40/533

(57) ABSTRACT

An office status notifier that may be placed at an employee's work station to let co-workers know where the employee is when they are not at their desk. The notifier may include a plurality of pre-printed (or user defined) cards that may rotate about one or more card holders. The card holders may be suspended from a base by a cross-member supported by legs. The notifier may be designed with an attachment mechanism to affix the notifier to a piece of office equipment, such as a top portion of a computer monitor.

### RELATED APPLICATION

This application is a continuation-in-part of U.S. patent application Ser. No. 11/495,306, filed Jul. 29, 2006, titled “Flip It.” Furthermore, this application is a continuation of U.S. patent application Ser. No. 13/747,017, filed Jan. 22, 2013, titled “Office Status Notifier,” which is a continuation of U.S. patent application Ser. No. 13/298,654, filed Nov. 17, 2011, titled “Office Status Notifier.” The disclosures of the above-referenced applications are hereby incorporated herein by reference in their entirety.

### BACKGROUND OF THE INVENTION

The present invention relates to a personal status notification device and, more particularly, to an office product adapted to be placed at an employee's work station to let co-workers know where the employee is when they are not at their desk.

When an employee goes on break, to lunch, to a meeting, or the like, they may put up a notice that states where they are. The problem is that if an employee uses a sticky note, they may fall down, get lost, fade or the like. If they use another form of a sign, they may be big, bulky and time consuming to set up. Further, different employees may use different methods, so a person looking for an employee that is away from their work station may have to look throughout the employee's work space to find a status notification note.

As can be seen, there is a need for a device that may be positioned in a predetermined location in an employee's work space that permits the employee to rapidly provide a notification as to their whereabouts while they are away.

### SUMMARY OF THE INVENTION

In one aspect of the present invention, a notification device comprises a base member; a support form having a first end and second end spaced apart from one another and attached to the base member; a plurality of rings disposed about the support form; a plurality of cards having holes therein, the rings passing through the holes in the cards, wherein the cards are suspended above the base member.

In another aspect of the present invention, a notification device comprises a base member; an adhesive element disposed on a bottom portion of the base member; a support form having a first end and second end spaced apart from one another and attached to the base member, wherein the support form has a shape of an elongated upside-down U-shape, and wherein the support form has first and second depressions along an upper portion of the upside-down U-shape; first and second rings adapted to rest in the first and second depressions; a plurality of cards having first and second holes therein, the first and second rings passing through the first and second holes in the cards, respectively, wherein the cards are suspended above the base member.

These and other features, aspects and advantages of the present invention will become better understood with reference to the following drawings, description and claims.

### BRIEF DESCRIPTION OF THE DRAWINGS

FIG. 1 is a perspective view of an office status notifier according to an exemplary embodiment of the present invention;

FIG. 2 is a front view of the office status notifier of FIG. 1;

FIG. 3 is a top view of the office status notifier of FIG. 1;

FIG. 4 is a side view of the office status notifier of FIG. 1;

FIG. 5 is a side view of the office status notifier of FIG. 1 illustrating rotational motion of a notification card about a ring; and

FIG. 6 is a bottom view of the office status notifier of FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, an embodiment of the present invention provides an office status notifier that may be placed at an employee's work station to let co-workers know where the employee is when they are not at their desk. The notifier may include a plurality of pre-printed (or user defined) cards that may rotate about one or more card holders. The card holders may be suspended from a base by a cross-member supported by legs. The notifier may be designed with an attachment mechanism to affix the notifier to a piece of office equipment, such as a top portion of a computer monitor.

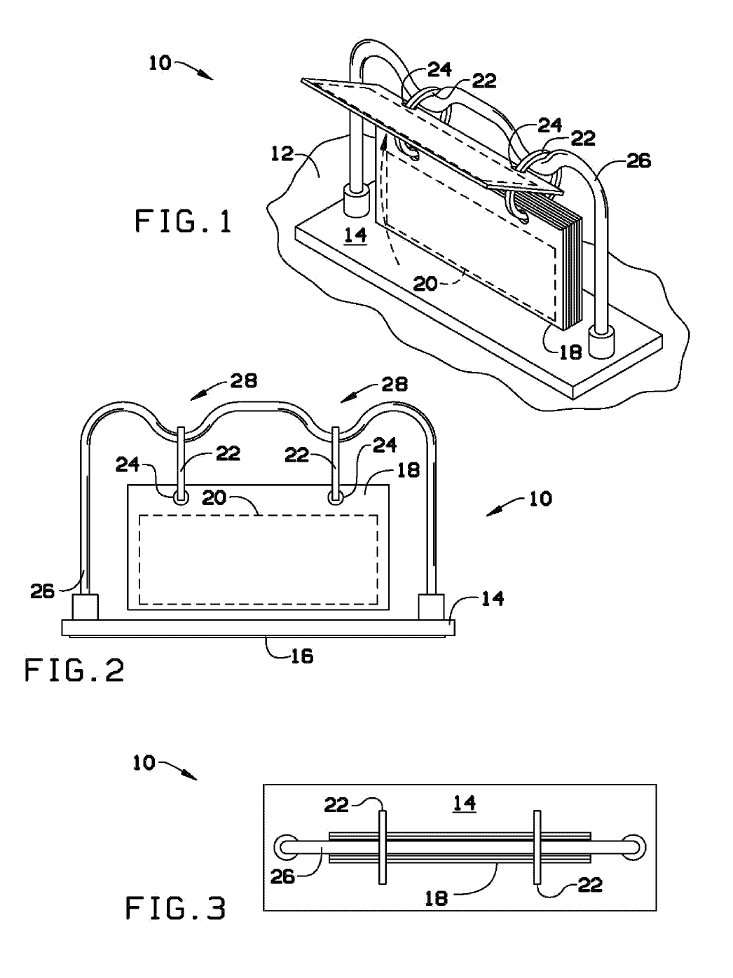

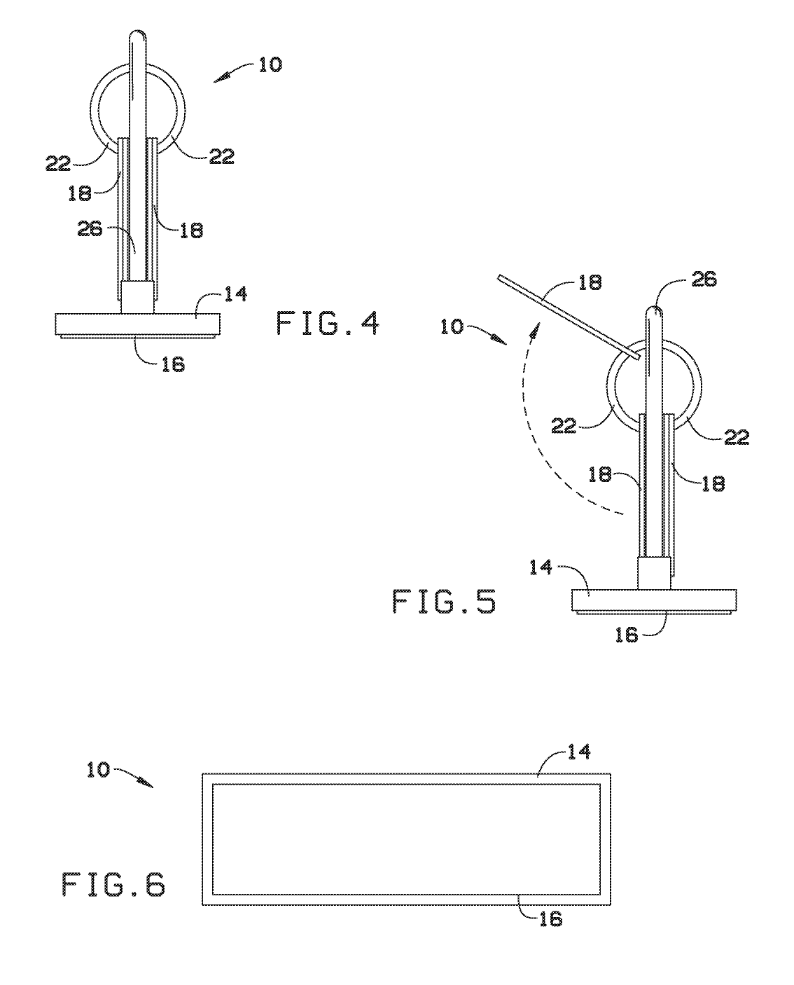

Referring to FIGS. 1 through 6, an office status notifier 10 (also referred to as notifier 10) may include a base 14 adapted to be attached to a surface 12, such as a top surface of a computer monitor (not shown). The base 14 may be of any size, typically rectangular (but may also be oval, circular, square, or some other non-geometric shape) having a length from about 3 inches to about 8 inches and a width from about 1 inch to about 3 inches. The base 14 may be made from, for example, plastic, metal, composite, or the like. A bottom side of the base 14 may include an adhesive 16. The adhesive 16 may permit the base 14 to attach to the surface 12. The adhesive 16 may be a pressure sensate adhesive, glue, double-stick tape, or one component of a hook and loop fastener, for example.

A support form 26 may extend from a first end of the base 14 to a second end of the base 14. The support form 26 may be generally shaped as an elongated, upside-down U-shape. The top portion of the upside-down U-shaped support form 26 may include first and second depressions 28. Card supporting rings 22 may be adapted to rest in the depressions 28. A plurality of cards 18 may have ring holes 24 adapted to pass the card supporting rings 22 therethrough. The cards 18 may have a message print area 20 thereupon. Each card 18 may have a pre-printed message in the message print area 20 that may suggest where an employee is located when they are not at their work station. In some embodiments, one or more of the cards 18 may have a blank message print area 20 adapted to accept a user created message. In some embodiments, the blank message print areas may be adapted to accept dry erase markers.

The rings 22 may be, for example, solid members with the cards 18 pre-attached. In some embodiments, the rings 22 may be formed like a key ring, with an overlapping band of resiliently separable material. In some embodiments, the rings 22 may have a spring or a threaded release (not shown) to permit addition or removal of cards.

To use, an employee may find a card 18 that displays a message stating where the employee will be while away from their desk. For example, the card 18 may state “vacation”, “conference room”, “copier”, “lunch”, and the like. Once the appropriate card is identified, the employee may turn any cards located in front of the appropriate card about the rings 22 so that the message print area 20 of the appropriate card is displayed in front.

The notifier 10 may be designed with a base 14 that may permit each employee to place the notifier 10 in a predetermined location. This location may be used throughout an entire office, so that a co-worker may quickly assess the whereabouts of an employee.

It should be understood, of course, that the foregoing relates to exemplary embodiments of the invention and that modifications may be made without departing from the spirit and scope of the invention as set forth in the following claims.

What is claimed is:

1. A method of providing a status notification, the method comprising:
providing a notification device, the notification device comprising:
a substantially planar base member lying in a first plane and having a top surface and a bottom surface;
a double-sided adhesive layer disposed on the bottom surface of the base member;
a support bar having a first end and second end spaced apart from one another and attached to the base member, the support bar lying in a second plane that is substantially perpendicular to the first plane;
a plurality of rings disposed about the support bar; and
a plurality of cards having holes therein, the plurality of rings passing through the holes in the cards, wherein the cards are suspended above the base member;
adhering the notification device to a top surface of a computer monitor; and
providing a status notification indicating a current location of a user by:
selecting a card of the plurality of cards; and
turning one or more cards of the plurality of cards that are located in front of the selected card about the plurality of rings, thereby displaying a message disposed on a message print area of the selected card indicating the current location of the user.

2. The method of claim 9, wherein the support bar comprises a plurality of depressions for retaining the rings at predetermined locations along a cross-bar of the support bar.

3. The method of claim 9, wherein the plurality of rings consists of two rings.

4. The method of claim 9, wherein the support bar has an upside-down U-shape.
